(19) United States
(12) Patent Application Publication
(10) Pub. No.: US 2025/0363197 A1
(43) Pub. Date: Nov. 27, 2025

(54) ENHANCED SECURE AUTHENTICATION SYSTEM UTILIZING DYNAMIC AVATAR INTERACTION AND ADVANCED MULTIMODAL BIOMETRIC ANALYSIS

(71) Applicants: Luke Abrams, London (GB); David Michael Gonen, Beverly Hills, CA (US)

(72) Inventors: Luke Abrams, London (GB); David Michael Gonen, Beverly Hills, CA (US)

(21) Appl. No.: 19/217,606

(22) Filed: May 23, 2025

Related U.S. Application Data
(60) Provisional application No. 63/651,024, filed on May 23, 2024.

(51) Int. Cl. G06F 21/32

(52) U.S. Cl. CPC G06F 21/32

(57) ABSTRACT

This invention extends its capabilities in digital authentication by incorporating sophisticated behavioral and fraud detection analyses alongside dynamic avatar interaction and multimodal biometric assessments. By analyzing a wide range of user behaviors, physiological responses, and interaction nuances, the system provides a comprehensive solution that not only detects traditional forms of identity fraud but also subtle signs of coercion or evasion. This multifaceted approach ensures a highly secure and user-responsive authentication process, making it exceedingly difficult for fraudsters to manipulate or bypass.

### CROSS REFERENCE TO RELATED APPLICATIONS

The present application claims priority from the following U.S. Provisional Application, the entire disclosure of which, including but not limited to any and all cited references, is incorporated herein by reference: U.S. Provisional Application No. 63/651,024 (filed May 23, 2024).

### FIELD OF THE INVENTION

This invention relates to advanced secure authentication technologies, integrating artificial intelligence, dynamic avatar-based interaction, and sophisticated multimodal biometric analysis, aimed at providing a robust and user-friendly authentication experience for a wide range of secure transactions and services.

### BACKGROUND OF THE INVENTION

Traditional biometric authentication systems often fall short in the face of sophisticated fraud techniques, such as deepfakes, due to reliance on static biometric measures. The proposed invention addresses these shortcomings by offering a dynamic, interactive, and highly secure authentication method that leverages the latest advancements in artificial intelligence and biometric analysis.

### SUMMARY OF THE INVENTION

The invention presents a cutting-edge biometric authentication system that employs an AI-powered, interactive digital avatar combined with a comprehensive multimodal biometric analysis technique. This system is uniquely capable of authenticating users with unparalleled accuracy, utilizing a blend of mature computer vision models and state-of-the-art transformer-based vision models for facial recognition, alongside advanced large language models (LLMs) for conversational analysis. This approach not only enhances security against fraud but also improves the user experience through natural, engaging interactions.

### BRIEF DESCRIPTION OF THE DRAWINGS

FIG. 1 illustrates an overview of the system architecture, highlighting the integration of the LLM, digital avatar, and the dual-model facial recognition system.

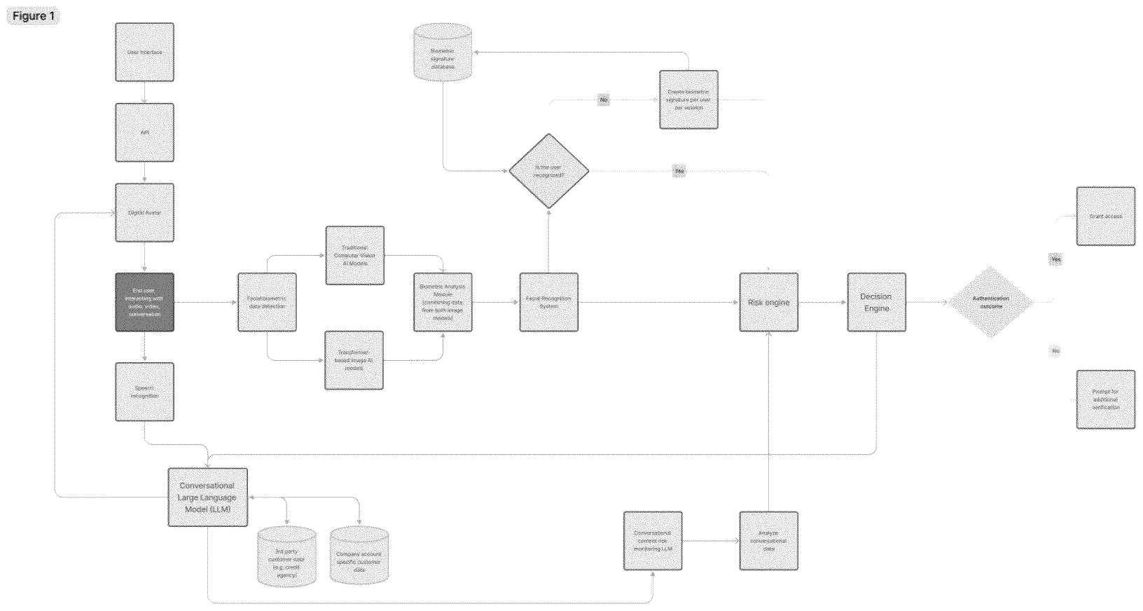

FIG. 2 illustrates a detailed flowchart of the authentication process, illustrating the steps from user engagement to authentication outcome, across various user scenarios.

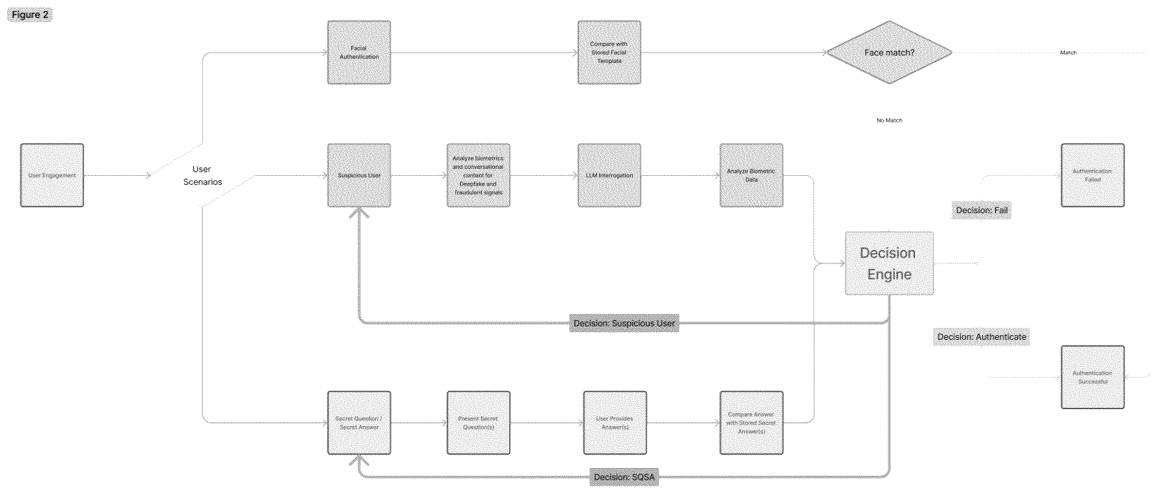

FIG. 3 illustrates an interface depiction showing a user interaction with the digital avatar, emphasizing the system's application in a password reset scenario.

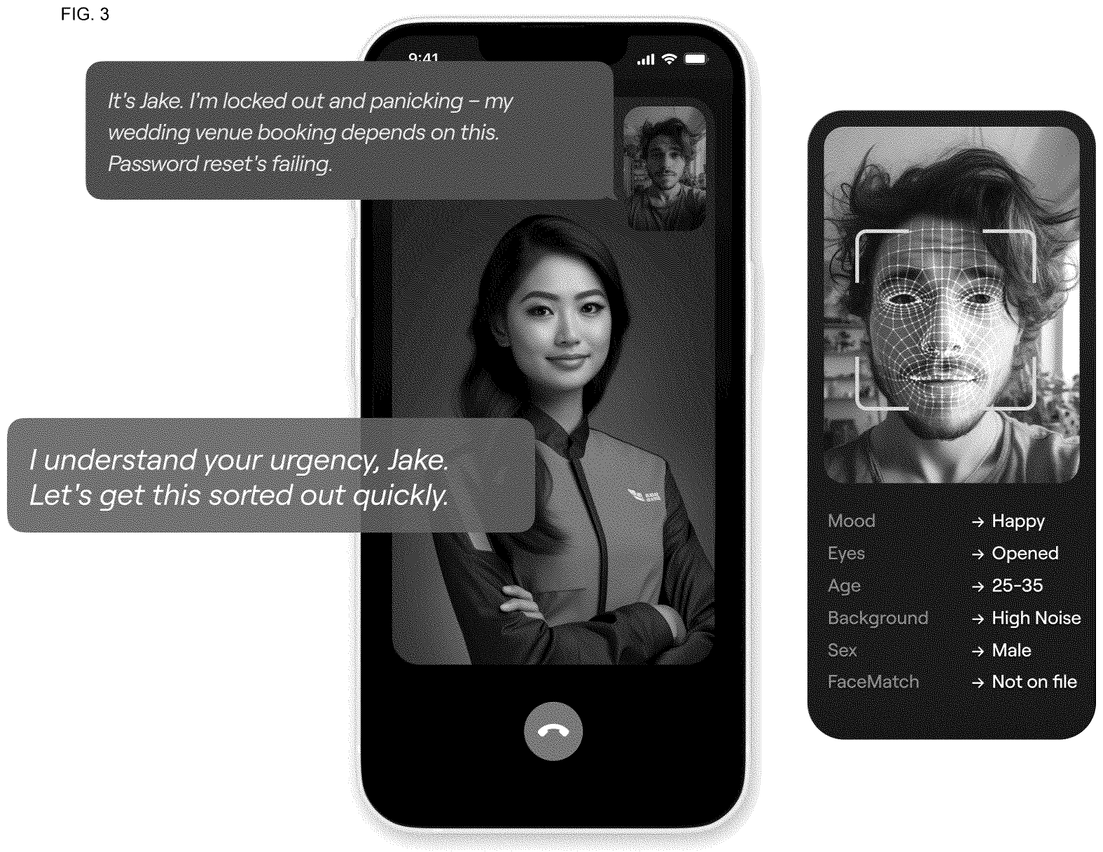

### DETAILED DESCRIPTION OF PREFERRED EMBODIMENTS

### Large Language Model (LLM):

At the heart of the interactive component is a sophisticated LLM that drives the digital avatar, enabling it to engage users in meaningful conversations. The LLM is adept at analyzing conversational nuances, including tone, content consistency, and language use, to authenticate the user based on known customer profiles.

### Real-Time Avatar:

The digital avatar serves as the interactive face of the system, designed to emulate human conversational behaviors, thereby facilitating a more natural and engaging user authentication process.

### Biometric Data Collection and Analysis:

### (1) Facial Biometrics:

The system employs a dual approach, combining traditional computer vision-based ML models with advanced transformer-based vision models, providing a robust framework for facial recognition that leverages the strengths of both mature and cutting-edge technologies.

### (2) Conversational Analysis:

Leveraging the LLM's capabilities, the system analyzes the conversational content for authenticity, scrutinizing the tone of voice and consistency of information with known customer data, including chosen language, language proficiency, accent, and historical interactions.

### Security Protocols:

The invention incorporates leading-edge security protocols and is in the process of obtaining compliance certifications from ISO, GDPR, PCI, and other relevant standards, ensuring the highest levels of data protection, privacy, and control.

### Application Integration and Use Cases:

The system is designed for seamless integration into client platforms via a RESTful API or SDK, supporting a wide array of use cases such as password resets, suspicious transaction verification, account recovery, and more, thereby significantly enhancing the security and efficiency of customer service operations.

### Enhanced Behavioral Analysis Techniques:

### (1) User Actions as Fraud Signals:

The system can now monitor and analyze various user actions during the authentication session that may indicate attempts at fraud or evasion. Actions such as turning off the camera, covering the camera lens, muting the microphone, or any physical obscuring of the user's face (e.g., wearing sunglasses, face masks, hats, or scarves) are flagged as potential fraud signals.

The avatar can interactively request the user to remove any obscuring items and ensure proper visibility and audibility for accurate identification and analysis.

### (2) Behavioral and Physiological Signs of Deception or Coercion:

(a) Advanced algorithms analyze visible signs of sweating, nervousness, and other physiological responses that may indicate stress or deception. The system also evaluates the user's behavior for signs of being under the influence, such as slurring or stuttering speech, and overall mood, including any shifts in mood during the session that might suggest discomfort or evasion.
(b) Behavioral metrics such as response timing, hesitation, and confidence level in answering questions are monitored to assess the genuineness and spontaneity of the responses.

### (3) Coercion Detection and Liveness Verification:

The authentication process includes checks for coercion detection by analyzing the context and environment around the user, looking for any signs of duress or third-party presence. Liveness detection is enhanced to not only verify physical presence but also ensure the active participation of the user without any external influence or interference.

What is claimed is:

1. A method for secure user authentication, comprising:
engaging a user in an interactive session with a digital avatar powered by a language model;
collecting and analyzing biometric data, including facial recognition and conversational analysis; and
authenticating the user based on a comparison with known user data and providing an authentication outcome.

2. The method of claim 1, wherein the interactive session is conducted in real-time.

3. The method of claim 1, wherein the language model is a large language model (LLM) capable of analyzing conversational nuances, including tone, content consistency, and language use.

4. The method of claim 1, wherein the facial recognition employs a combination of computer vision models and transformer-based models.

5. The method of claim 1, wherein the conversational analysis includes examining the tone of voice and consistency of information with known user data, such as language proficiency and historical interactions.

6. The method of claim 1, further comprising the application of the authentication method in various user scenarios, including password resets, account onboarding, and transaction verification.

7. A system for secure user authentication, comprising:
an interactive digital avatar driven by a language model;
a biometric analysis module utilizing facial recognition and conversational analysis; and
a decision engine that determines the authenticity of the user's identity based on the biometric analysis results.

8. The system of claim 7, wherein the language model is an LLM, and the facial recognition employs a combination of traditional and transformer-based models.

9. The system of claim 7, further comprising a module for ensuring compliance with various security and privacy standards, such as ISO, GDPR, and PCI.

10. The system of claim 7, wherein the system is integrated into client platforms via an API, supporting a wide array of use cases and user scenarios.

11. A method for enhanced digital authentication, further comprising:
monitoring user actions that might indicate fraudulent attempts, including obscuring the camera, muting audio inputs, or wearing items that hinder biometric analysis;
analyzing physiological and behavioral signs of stress, deception, or coercion during the authentication process; and
dynamically adjusting the authentication protocol based on behavioral assessments to enhance fraud detection and ensure user compliance and safety.
